(19) United States
(12) Patent Application Publication
(10) Pub. No.: US 2008/0089764 A1
(43) Pub. Date: Apr. 17, 2008

(54) Combined truck and garbage container sanitizing system and associated method

(76) Inventor: Felix Vistro, Camarillo, CA (US)

Correspondence Address: ASHKAN NAJAFI, P.A., 6817 SOUTHPOINT PARKWAY, SUITE 2301, JACKSONVILLE, FL, 32216, US

(21) Appl. No.: 11/974,474

(22) Filed: Oct. 12, 2007

Related U.S. Application Data
(60) Provisional application No. 60/850,808, filed on Oct. 12, 2006.

(51) Int. Cl. B65F 7/00; B08B 1/00; B08B 9/087; B65F 3/02

(52) U.S. Cl. 414/408; 134/184; 134/42; 15/56

(57) ABSTRACT

A combined truck and garbage container sanitizing system includes a truck with a rearwardly positioned collection bin provided with a support platform nested therein. Such a collection bin has an open top end. The system further includes a controller seated within a driver compartment of the truck, and a mechanism for selectively biasing the garbage container between an upright position from the curbside to an inverted position located partially within the collection bin of the truck while a driver of the truck remains seated within the truck. A mechanism is included for cleaning an interior surface of the garbage container while situated at the inverted position such that fluids and debris are channeled directly into the collection bin during cleaning procedures.

### CROSS REFERENCE TO RELATED APPLICATIONS

This application claims the benefit of U.S. Provisional Application No. 60/850,808, filed Oct. 12, 2006, the entire disclosures of which are incorporated herein by reference.

### STATEMENT REGARDING FEDERALLY SPONSORED RESEARCH OR DEVELOPMENT

Not Applicable.

### REFERENCE TO A MICROFICHE APPENDIX

Not Applicable.

### BACKGROUND OF THE INVENTION

1. Technical Field

This invention relates to sanitizing systems and, more particularly, to a combined truck and garbage container sanitizing system for cleaning a garbage container at a curbside location.

2. Prior Art

Our concepts about garbage are fairly recent. Until the mid-18th century, garbage was simply tossed out the window. This became a problem as urban densities increased and unsanitary conditions incubated disease. The first trash collection service began in 18th-century England and France, where carters were paid by individuals to carry trash and discard it on the outskirts of town, thus disposal in open pits became routine. At the start of the 20th century, fear of disease caused by “miasma” rising from open-pit dumps gave rise to the first rudimentary sanitary land filling techniques (covering garbage with soil every day) and landfills proliferated across the continent, frequently sited on wetlands to convert this useless property into filled land suitable for development.

Trash collection and hauling services in urban areas was primarily supplied by local governments as a part of municipal services provided to residents. In the last few decades a combination of new regulations and shrinking municipal budgets has prompted significant change in waste management services. Subsequently, many local governments privatized municipal services such as trash collection and trash hauling. Extensive experience now shows that private firms can collect a city's trash at up to 70 percent less cost than a similar public service. This is primarily because private employees tend to be two or three times as productive as public employees. So, private firms can often give improved service while still lowering costs. Just as important, the same experience has demonstrated that private firms provide higher quality service as well.

Regardless of whether trash collection is provided by the local government or a private contractor, the garbage container is very seldom washed and sanitized by the user, after the trash has been emptied and the container returned to curbside. This, of course, results in a smelly, unhygienic trash container being returned to a household. Obviously, it would be advantageous to provide users with a means for regularly washing and sanitizing their trash containers.

U.S. Pat. No. 4,211,745 to Boyd discloses spray nozzles that are mounted on a refuse collection truck mechanically equipped to pick up refuse containers and dump the contents into the truck. The spray nozzles spray an insecticide, a deodorant, and a rust preventative lubricant into the container after it has been emptied, but before it is lowered to the ground. Unfortunately, this prior art example is not designed for both cleaning and disinfecting the containers.

U.S. Pat. No. 5,964,229 to Brendel discloses a device for use with a garbage truck, particularly a vehicle for receiving and transporting so-called biological or organic garbage. The device includes tilting arrangements at the end of the vehicle for tilting a can containing garbage upwardly for emptying the can and for tilting the can backwardly into its initial position after the can has been emptied. The garbage dropped into the hold of the vehicle and the emptied can are sprayed with a disinfecting agent for treating the garbage and cleaning the can. The spraying device includes a spray nozzle which is movable between a first spray position for spraying in the direction of the garbage in the hold of the garbage truck and a second spray position for spraying in a second spray direction in which the spray jet is directed into the interior of the can which is in its upwardly tilted position. In addition, a control is provided which, after the can has been emptied, starts spraying of the garbage in the first spray position and which, subsequently and before tilting the can back into its initial position, moves the spray nozzle into the second spray position and carries out spraying of the interior of the empty can. Unfortunately, this prior art example does not include cleaning brushes.

U.S. Pat. No. 6,554,008 to Dewey discloses a system and a method for cleaning a trash bin. In a preferred embodiment, the system includes nozzles coupled to lifting means. The nozzles are aimed at the inside of the trash bin. The method includes the steps of lifting the trash bin, inverting it to empty its contents, spraying the inside of the trash bin, and returning the trash bin to the ground. An additional step may include spraying the trash bin when it is returned to the ground. Unfortunately, this prior art example does not include a method for disinfecting the containers.

Accordingly, the present invention is disclosed in order to overcome the above noted shortcomings. The present invention is convenient and easy to use, durable in design, and designed for cleaning a garbage container at a curbside location. The combined truck and garbage container sanitizing system is simple to use, inexpensive, and designed for many years of repeated use.

### BRIEF SUMMARY OF THE INVENTION

In view of the foregoing background, it is therefore an object of the present invention to provide an apparatus for cleaning a garbage container at a curbside location. These and other objects, features, and advantages of the invention are provided by a combined truck and garbage container sanitizing system.

A combined truck and garbage container sanitizing system includes a truck with a rearwardly positioned collection bin provided with a support platform nested therein. Such a collection bin effectively has an open top end. The system further includes a controller seated within a driver compartment of the truck.

The system further includes a mechanism for conveniently and selectively biasing the garbage container between an upright position from the curbside to an inverted position located partially within the collection bin of the truck while a driver of the truck remains seated within the truck. Such a garbage container biasing mechanism includes an anchor panel directly affixed to the lateral side of the truck and extending downwardly from a top edge thereof, and first and second power-operated lifting arms pivotally affixed to each other. Such a first lifting arm is pivotally coupled to the anchor panel.

The garbage container biasing mechanism further includes a U-shaped bracket directly affixed to the second arm, and a plurality of gripping fingers operably connected to the U-shaped bracket. Each of such gripping fingers is selectively articulated between compressed and expanded positions.

The first lifting arm has a proximal end pivotally connected to the anchor panel, and the second lifting arm has a proximal end directly and pivotally connected to a distal end of the first lifting arm. The second lifting arm has a distal end directly and pivotally connected to the U-shaped bracket in such a manner that the first and second lifting arms advantageously and simultaneously pivot while the U-shaped bracket is adapted from the curbside location towards the collection bin.

The system further includes a mechanism for effectively cleaning an interior surface of the garbage container while situated at the inverted position such that fluids and debris are channeled directly into the collection bin during cleaning procedures. Such a garbage container cleaning mechanism includes a reservoir seated within the collection bin and containing a predetermined quantity of a cleaning agent, a motorized pump electrically coupled directly to the controller, a power source electrically coupled to the controller and the motorized pump, a sensor seated within the reservoir and positioned adjacent to the open top face thereof, an interface electrically coupled to the motorized pump and located downstream thereof, a plurality of discharge nozzles electrically coupled to the interface and in fluid communication with the reservoir, and a plurality of brushes electrically coupled to the interface.

The motorized pump is conveniently responsive to the control signals from the controller and thereby generates and transmits first and second input signals to the interface based upon information received from the control signals. The sensor generates and transmits a third input signal to the interface upon detecting a presence of the garbage container within the collection bin.

The interface includes an OR logic gate electrically coupled directly to the motorized pump, and an AND logic gate electrically coupled directly to the sensor and the OR logic gate respectively. Such an OR logic gate advantageously generates and transmits a first output signal to the AND logic gate when at least one of the first and second input signals has a true value. The AND logic gate generates and transmits a true second output signal when both of the third input signal and the first output signal have true values. Such a second output signal has a false value when at least one of the third input signal and the first output signal has a false value.

The controller is electrically coupled to the garbage container biasing mechanism and the garbage container cleaning mechanism respectively, and generates and transmits a plurality of control signals based upon user inputs generated from the driver compartment. The garbage container cleaning mechanism and the garbage container biasing mechanism are simultaneously operable, and the brushes are effectively connected in series with the motorized pump.

A method for cleaning a garbage container at a curbside location includes the steps of: providing a truck with a rearwardly positioned collection bin provided with a support platform nested therein and an open top end; providing a controller seated within a driver compartment of the truck; the control generating and transmitting a plurality of control signals based upon user inputs generated from the driver compartment; selectively biasing the garbage container between an upright position from the curbside to an inverted position located partially within the collection bin of the truck while a driver of the truck remains seated within the truck; and cleaning an interior surface of the garbage container while situated at the inverted position such that fluids and debris are channeled directly into the collection bin during cleaning procedures.

The method further includes the steps of: directly affixing an anchor panel to the lateral side of the truck by extending the anchor panel downwardly from a top edge of the truck; pivotally affixing first and second power-operated lifting arms to each other; pivotally coupling the first lifting arm coupled to the anchor panel; directly affixing a U-shaped bracket to the second arm; operably connecting a plurality of gripping fingers to the U-shaped bracket; and selectively articulating each of the gripping fingers between compressed and expanded positions.

The method further includes the steps of: pivotally connecting a proximal end of the first lifting arm to the anchor panel; directly and pivotally connecting a proximal end of the second lifting arm to the a distal end of the first lifting arm; pivotally connecting a distal end of the second lifting arm to the U-shaped bracket; and simultaneously pivoting the first and second lifting arms by adapting the U-shaped bracket from the curbside location towards the collection bin.

The method further includes the steps of: seating a reservoir seated within the collection bin; depositing a predetermined quantity of a cleaning agent within the reservoir; electrically coupling a motorized pump directly to the controller; electrically coupling a power source to the controller and the motorized pump respectively; seating a sensor within the reservoir by positioning the sensor adjacent to the open top face thereof; electrically coupling an interface to the motorized pump by located the interface downstream thereof; electrically coupling a plurality of discharge nozzles to the interface by attaching the discharge nozzles in fluid communication with the reservoir; electrically coupling a plurality of brushes to the interface; the motorized pump generating and transmitting first and second input signals to the interface based upon information received from the control signals; and the sensor generating and transmitting a third input signal to the interface upon detecting a presence of the garbage container within the collection bin.

The method further includes the steps of: electrically coupling an OR logic gate directly to the motorized pump; electrically coupling an AND logic gate directly to the sensor and the OR logic gate respectively; the OR logic gate generating and transmitting a first output signal to the AND logic gate when at least one of the first and second input signals has a true value; the AND logic gate generating and transmitting a true second output signal when both of the third input signal and the first output signal have true values; and the AND logic gate generating and transmitting a second output signal with a false value when at least one of the third input signal and the first output signal has a false value.

There has thus been outlined, rather broadly, the more important features of the invention in order that the detailed description thereof that follows may be better understood, and in order that the present contribution to the art may be better appreciated. There are additional features of the invention that will be described hereinafter and which will form the subject matter of the claims appended hereto.

It is noted the purpose of the foregoing abstract is to enable the U.S. Patent and Trademark Office and the public generally, especially the scientists, engineers and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

### BRIEF DESCRIPTION OF THE SEVERAL VIEWS OF THE DRAWING

The novel features believed to be characteristic of this invention are set forth with particularity in the appended claims. The invention itself, however, both as to its organization and method of operation, together with further objects and advantages thereof, may best be understood by reference to the following description taken in connection with the accompanying drawings in which:

FIG. 1 is a perspective view of a combined truck and garbage container sanitizing system, in accordance with the present invention;

FIG. 2 is a top planar perspective view of a combined truck and garbage container sanitizing system, in accordance with the present invention;

FIG. 3 is a rear elevational and perspective view of a combined truck and garbage container sanitizing system, in accordance with the present invention;

FIG. 4 is a schematic block diagram of a garbage container cleaning mechanism, in accordance with the present invention; and

FIG. 5 is a schematic block diagram of an interface, in accordance with the present invention.

### DETAILED DESCRIPTION OF THE INVENTION

The present invention will now be described more fully hereinafter with reference to the accompanying drawings, in which a preferred embodiment of the invention is shown. This invention may, however, be embodied in many different forms and should not be construed as limited to the embodiment set forth herein. Rather, this embodiment is provided so that this application will be thorough and complete, and will fully convey the true scope of the invention to those skilled in the art. Like numbers refer to like elements throughout the figures.

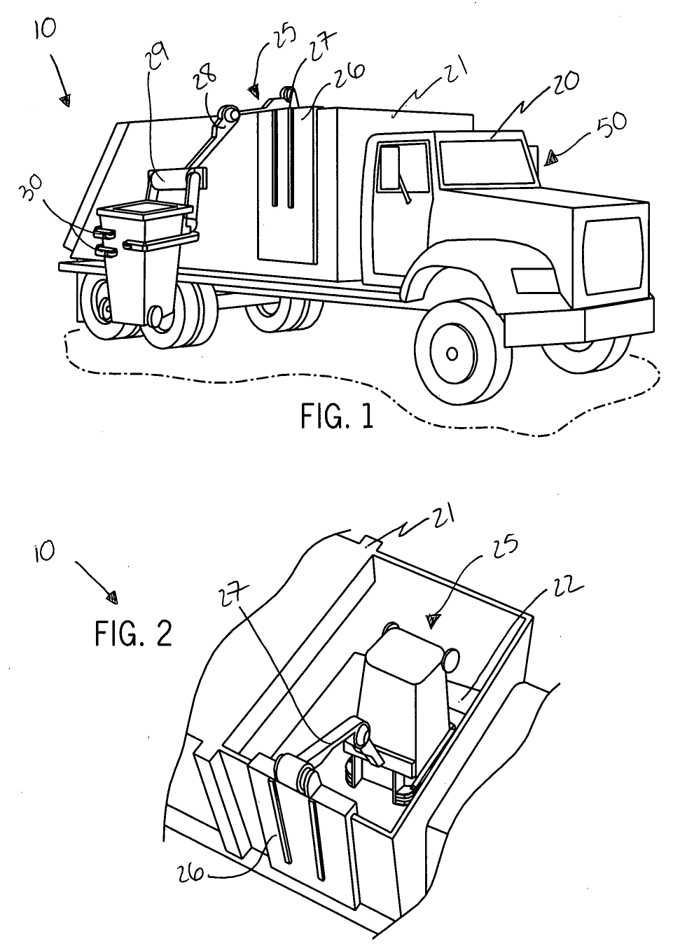

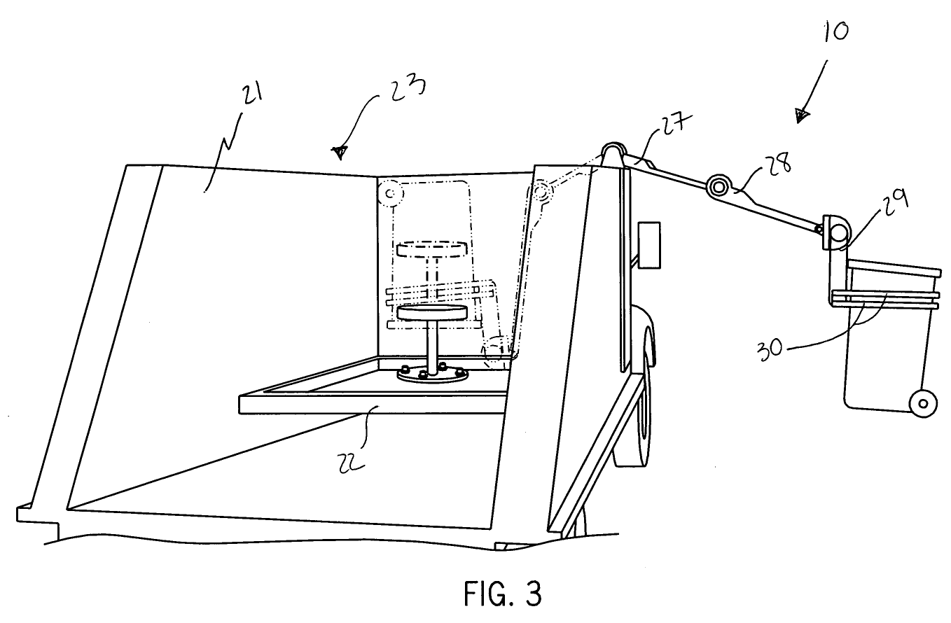

The system of this invention is referred to generally in FIGS. 1-5 by the reference numeral 10 and is intended to protect a combined truck and garbage container sanitizing system. It should be understood that the system 10 may be used to sanitize many different types of containers and should not be limited to sanitizing only those types of containers mentioned herein.

Referring initially to FIGS. 1, 2 and 3, a combined truck and garbage container sanitizing system 10 includes a truck 20 with a rearwardly positioned collection bin 21 provided with a support platform 22 nested therein. Such a collection bin 21 has an open top end 23. The system 10 further includes a controller 24 seated within a driver compartment 50 of the truck 20. The controller 24 enables the driver to operate the system 10 without leaving the driver compartment 50.

Referring again to FIGS. 1, 2 and 3, the system 10 further includes a mechanism 25 for selectively biasing the garbage container 51 between an upright position from the curbside to an inverted position located partially within the collection bin 21 of the truck 20 while a driver of the truck remains seated within the truck 20. Such a garbage container biasing mechanism 25 includes an anchor panel 26 directly affixed, without the use of intervening elements, to the lateral side of the truck and extending downwardly from a top edge thereof, and first and second power-operated lifting arms 27, 28 pivotally affixed to each other. Such a first lifting arm 27 is pivotally coupled to the anchor panel 26. The garbage container biasing mechanism 25 is used for lifting and emptying a garbage container 51.

Referring again to FIGS. 1, 2 and 3, the garbage container biasing mechanism 25 further includes a U-shaped bracket 29 directly affixed to the second arm 28, and a plurality of gripping fingers 30 operably connected to the U-shaped bracket 29. Each of such gripping fingers 30 is selectively articulated between compressed and expanded positions.

The first lifting arm 27 has a proximal end pivotally connected to the anchor panel 26, and the second lifting arm 28 has a proximal end directly and pivotally connected to a distal end of the first lifting arm 27. The second lifting arm 28 has a distal end directly and pivotally connected, without the use of intervening elements, to the U-shaped bracket 29 in such a manner that the first and second lifting arms 27, 28 simultaneously pivot while the U-shaped bracket 29 is adapted from the curbside location towards the collection bin 21.

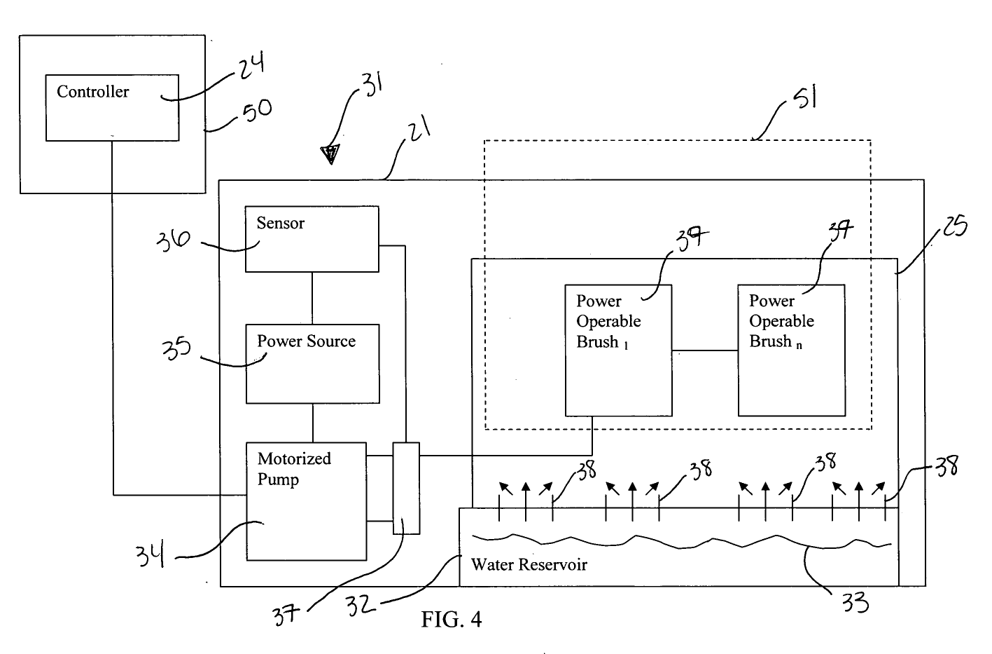

Referring to FIG. 4, the system 10 further includes a mechanism 31 for cleaning an interior surface of the garbage container while situated at the inverted position which is essential such that fluids and debris are channeled directly into the collection bin 21 during cleaning procedures. Such a garbage container cleaning mechanism 31 includes a reservoir 32 seated within the collection bin 21 and containing a predetermined quantity of a cleaning agent 33, a motorized pump 34 electrically coupled directly, without the use of intervening elements, to the controller 24, a power source 35 electrically coupled to the controller 24 and the motorized pump 34, a sensor 36 seated within the reservoir 32 and positioned adjacent to the open top face thereof, an interface 37 electrically coupled to the motorized pump 34 and located downstream thereof, a plurality of discharge nozzles 38 electrically coupled to the interface 37 and in fluid communication with the reservoir 32, and a plurality of brushes 39 electrically coupled to the interface 37. The garbage container cleaning mechanism 31 cleans and sanitizes the container 51 to maintain healthful conditions.

The motorized pump 34 is responsive to the control signals from the controller 24 and thereby generates and transmits first and second input signals to the interface based upon information received from the control signals. The sensor 36 generates and transmits a third input signal to the interface 37 upon detecting a presence of the garbage container within the collection bin 21.

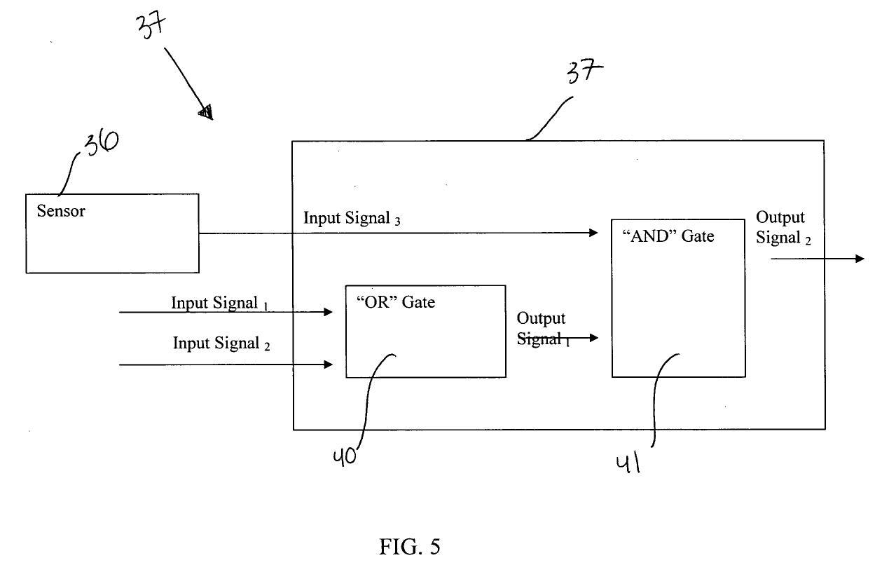

Referring to FIG. 5, the interface 37 includes an OR logic gate 40 electrically coupled directly, without the use of intervening elements, to the motorized pump 34, and an AND logic gate 41 electrically coupled directly, without the use of intervening elements, to the sensor 36 and the OR logic gate 40 respectively. Such an OR logic gate 40 generates and transmits a first output signal to the AND logic gate 41 when at least one of the first and second input signals has a true value. The AND logic gate 41 generates and transmits a true second output signal when both of the third input signal and the first output signal have true values. Such a second output signal has a false value when at least one of the third input signal and the first output signal has a false value.

The controller 24 is electrically coupled to the garbage container biasing mechanism and the garbage container cleaning mechanism 25, 31 respectively, and generates and transmits a plurality of control signals based upon user inputs generated from the driver compartment 50. The garbage container cleaning mechanism 31 and the garbage container biasing mechanism 25 are simultaneously operable, and the brushes 39 are connected in series with the motorized pump 34.

The system includes a utility vehicle that is equipped with a washing and sanitizing system which is designed for use in conjunction with household garbage containers. Of course, the system may be designed to wash a variety of objects other than garbage containers, as is obvious to a person of ordinary skill in the art. The utility vehicle follows a conventional trash collection vehicle in order to effectively clean and sanitize a garbage container after it has been emptied. The utility vehicle includes a robotic arm that is conveniently controlled from the cab of the utility vehicle and is used to securely clamp and lift a garbage container into an enclosed utility vehicle bed. The robotic arm effectively positions the interior of the garbage container in line with a plurality of pressurized water jets, which are crucial for advantageously thoroughly washing the entire interior surface area of the garbage container.

After the trash container is washed, a liquid, sanitizing and disinfecting solution is sprayed into the interior area of the trash container. The robotic arm then lifts the garbage container and drains all residual liquids into the enclosed bed before returning the container to curbside. The thoroughly cleaned garbage container is then returned to the household or business. Of course, the cleaning and sanitizing service could be provided on a regular basis, perhaps once a month, and a small fee could be charged for the service, as is obvious to a person of ordinary skill in the art.

The present invention, as claimed, provides the unexpected and unpredictable benefit of a system that is convenient and easy to use, provides considerable time savings, is durable and reliable in design, and provides users with an effective means to maintain their garbage containers at a clean and sanitized state. The present invention helps to reduce the risk of disease causing bacteria and other such organisms from growing in a garbage container and becoming a health risk. Such a system is easy to use, virtually requiring no effort on the homeowner's part, thus advantageously saving them a considerable amount of time. The garbage container sanitizing system ensures that garbage can still be collected on a regular basis, while also improving the safety of all persons coming into contact with those containers.

In use, a method for cleaning a garbage container at a curbside location includes the steps of: providing a truck 20 with a rearwardly positioned collection bin 21 provided with a support platform 22 nested therein and an open top end 23; providing a controller 24 seated within a driver compartment 50 of the truck 20; the control 24 generating and transmitting a plurality of control signals based upon user inputs generated from the driver compartment 50; selectively biasing the garbage container 51 between an upright position from the curbside to an inverted position located partially within the collection bin 21 of the truck 20 while a driver of the truck 20 remains seated within the truck; and cleaning an interior surface of the garbage container 51 while situated at the inverted position such that fluids and debris are channeled directly into the collection bin 21 during cleaning procedures.

In use, the method further includes the steps of: directly affixing an anchor panel 26 to the lateral side of the truck 20 by extending the anchor panel 26 downwardly from a top edge of the truck 20; pivotally affixing first and second power-operated lifting arms 27, 28 to each other; pivotally coupling the first lifting arm 27 coupled to the anchor panel 26; directly affixing, without the use of intervening elements, a U-shaped bracket 29 to the second arm 28; operably connecting a plurality of gripping fingers 30 to the U-shaped bracket 29; and selectively articulating each of the gripping fingers 30 between compressed and expanded positions.

In use, the method further includes the steps of: pivotally connecting a proximal end of the first lifting arm 27 to the anchor panel 26; directly and pivotally connecting, without the use of intervening elements, a proximal end of the second lifting arm 28 to the a distal end of the first lifting arm 27; pivotally connecting a distal end of the second lifting arm 28 to the U-shaped bracket 29; and simultaneously pivoting the first and second lifting arms 27, 28 by adapting the U-shaped bracket 29 from the curbside location towards the collection bin 21.

In use, the method further includes the steps of: seating a reservoir 32 seated within the collection bin 21; depositing a predetermined quantity of a cleaning agent 33 within the reservoir 32; electrically coupling a motorized pump 34 directly to the controller 24; electrically coupling a power source 35 to the controller 24 and the motorized pump 34 respectively; seating a sensor 36 within the reservoir 32 by positioning the sensor 36 adjacent to the open top face thereof; electrically coupling an interface 37 to the motorized pump 34 by located the interface downstream thereof; electrically coupling a plurality of discharge nozzles 38 to the interface 37 by attaching the discharge nozzles 38 in fluid communication with the reservoir 32; electrically coupling a plurality of brushes 39 to the interface 37; the motorized pump 34 generating and transmitting first and second input signals to the interface 37 based upon information received from the control signals; and the sensor 36 generating and transmitting a third input signal to the interface 37 upon detecting a presence of the garbage container 51 within the collection bin 21.

In use, the method further includes the steps of: electrically coupling an OR logic gate 40 directly to the motorized pump 34; electrically coupling an AND logic gate 41 directly to the sensor 36 and the OR logic gate 40 respectively; the OR logic gate 40 generating and transmitting a first output signal to the AND logic gate 41 when at least one of the first and second input signals has a true value; the AND logic gate 41 generating and transmitting a true second output signal when both of the third input signal and the first output signal have true values; and the AND logic gate 41 generating and transmitting a second output signal with a false value when at least one of the third input signal and the first output signal has a false value.

While the invention has been described with respect to a certain specific embodiment, it will be appreciated that many modifications and changes may be made by those skilled in the art without departing from the spirit of the invention. It is intended, therefore, by the appended claims to cover all such modifications and changes as fall within the true spirit and scope of the invention.

In particular, with respect to the above description, it is to be realized that the optimum dimensional relationships for the parts of the present invention may include variations in size, materials, shape, form, function and manner of operation. The assembly and use of the present invention are deemed readily apparent and obvious to one skilled in the art.

What is claimed as new and what is desired to secure by Letters Patent of the United States is:

1. A combined truck and garbage container sanitizing system for cleaning a garbage container at a curbside location, said combined truck and garbage container sanitizing system comprising:
a truck having a rearwardly positioned collection bin provided with a support platform nested therein, said collection bin having an open top end;
a controller seated within a driver compartment of said truck;
means for selectively biasing the garbage container between an upright position from the curbside to an inverted position located partially within said collection bin of said truck while a driver of the truck remains seated within the truck; and
means for cleaning an interior surface of the garbage container while situated at the inverted position such that fluids and debris are channeled directly into said collection bin during cleaning procedures;
wherein said controller is electrically coupled to said garbage container biasing means and said garbage container cleaning means respectively, said control generating and transmitting a plurality of control signals based upon user inputs generated from the driver compartment.

2. The combined truck and garbage container sanitizing system of claim 1, wherein said garbage container biasing means comprises:
an anchor panel directly affixed to the lateral side of said truck and extending downwardly from a top edge thereof;
first and second power-operated lifting arms pivotally affixed to each other, said first lifting arm being pivotally coupled to said anchor panel;
a U-shaped bracket directly affixed to said second arm; and
a plurality of gripping fingers operably connected to said U-shaped bracket, each of said gripping fingers being selectively articulated between compressed and expanded positions.

3. The combined truck and garbage container sanitizing system of claim 2, wherein said first lifting arm has a proximal end pivotally connected to said anchor panel, said second lifting arm having a proximal end directly and pivotally connected to said a distal end of said first lifting arm, said second lifting arm having a distal end directly and pivotally connected to said U-shaped bracket in such a manner that said first and second lifting arms simultaneously pivot while said U-shaped bracket is adapted from the curbside location towards said collection bin.

4. The combined truck and garbage container sanitizing system of claim 3, wherein said garbage container cleaning means comprises:
a reservoir seated within said collection bin and containing a predetermined quantity of a cleaning agent;
a motorized pump electrically coupled directly to said controller;
a power source electrically coupled to said controller and said motorized pump;
a sensor seated within said reservoir and positioned adjacent to said open top face thereof;
an interface electrically coupled to said motorized pump and located downstream thereof;
a plurality of discharge nozzles electrically coupled to said interface and being in fluid communication with said reservoir; and
a plurality of brushes electrically coupled to said interface;
wherein said motorized pump is responsive to said control signals from said controller and thereby generates and transmits first and second input signals to said interface based upon information received from said control signals;
wherein said sensor generates and transmits a third input signal to said interface upon detecting a presence of the garbage container within said collection bin.

5. The combined truck and garbage container sanitizing system of claim 4, wherein said interface comprises:
an OR logic gate electrically coupled directly to said motorized pump; and
an AND logic gate electrically coupled directly to said sensor and said OR logic gate respectively;
wherein said OR logic gate generates and transmits a first output signal to said AND logic gate when at least one of said first and second input signals has a true value;
wherein said AND logic gate generates and transmits a true second output signal when both of said third input signal and said first output signal have true values, said second output signal have a false value when at least one of said third input signal and said first output signal has a false value.

6. The combined truck and garbage container sanitizing system of claim 4, wherein said brushes are connected in series with said motorized pump.

7. A combined truck and garbage container sanitizing system for cleaning a garbage container at a curbside location, said combined truck and garbage container sanitizing system comprising:
a truck having a rearwardly positioned collection bin provided with a support platform nested therein, said collection bin having an open top end;
a controller seated within a driver compartment of said truck;
means for selectively biasing the garbage container between an upright position from the curbside to an inverted position located partially within said collection bin of said truck while a driver of the truck remains seated within the truck; and
means for cleaning an interior surface of the garbage container while situated at the inverted position such that fluids and debris are channeled directly into said collection bin during cleaning procedures;
wherein said controller is electrically coupled to said garbage container biasing means and said garbage container cleaning means respectively, said control generating and transmitting a plurality of control signals based upon user inputs generated from the driver compartment;
wherein said garbage container cleaning means and said garbage container biasing means are simultaneously operable.

8. The combined truck and garbage container sanitizing system of claim 7, wherein said garbage container biasing means comprises:
an anchor panel directly affixed to the lateral side of said truck and extending downwardly from a top edge thereof;
first and second power-operated lifting arms pivotally affixed to each other, said first lifting arm being pivotally coupled to said anchor panel;
a U-shaped bracket directly affixed to said second arm; and
a plurality of gripping fingers operably connected to said U-shaped bracket, each of said gripping fingers being selectively articulated between compressed and expanded positions.

9. The combined truck and garbage container sanitizing system of claim 8, wherein said first lifting arm has a proximal end pivotally connected to said anchor panel, said second lifting arm having a proximal end directly and pivotally connected to said a distal end of said first lifting arm, said second lifting arm having a distal end directly and pivotally connected to said U-shaped bracket in such a manner that said first and second lifting arms simultaneously pivot while said U-shaped bracket, is adapted from the curbside location towards said collection bin.

10. The combined truck and garbage container sanitizing system of claim 9, wherein said garbage container cleaning means comprises:
a reservoir seated within said collection bin and containing a predetermined quantity of a cleaning agent;
a motorized pump electrically coupled directly to said controller;
a power source electrically coupled to said controller and said motorized pump;
a sensor seated within said reservoir and positioned adjacent to said open top face thereof;
an interface electrically coupled to said motorized pump and located downstream thereof;
a plurality of discharge nozzles electrically coupled to said interface and being in fluid communication with said reservoir; and
a plurality of brushes electrically coupled to said interface;
wherein said motorized pump is responsive to said control signals from said controller and thereby generates and transmits first and second input signals to said interface based upon information received from said control signals;
wherein said sensor generates and transmits a third input signal to said interface upon detecting a presence of the garbage container within said collection bin.

11. The combined truck and garbage container sanitizing system of claim 10, wherein said interface comprises:
an OR logic gate electrically coupled directly to said motorized pump; and
an AND logic gate electrically coupled directly to said sensor and said OR logic gate respectively;
wherein said OR logic gate generates and transmits a first output signal to said AND logic gate when at least one of said first and second input signals has a true value;
wherein said AND logic gate generates and transmits a true second output signal when both of said third input signal and said first output signal have true values, said second output signal have a false value when at least one of said third input signal and said first output signal has a false value.

12. The combined truck and garbage container sanitizing system of claim 10, wherein said brushes are connected in series with said motorized pump.

13. A method for cleaning a garbage container at a curbside location, said method comprising the steps of:
a. providing a truck having a rearwardly positioned collection bin provided with a support platform nested therein and an open top end;
b. providing a controller seated within a driver compartment of said truck;
c. said control generating and transmitting a plurality of control signals based upon user inputs generated from the driver compartment;
d. selectively biasing the garbage container between an upright position from the curbside to an inverted position located partially within said collection bin of said truck while a driver of the truck remains seated within the truck; and
e. cleaning an interior surface of the garbage container while situated at the inverted position such that fluids and debris are channeled directly into said collection bin during cleaning procedures.

14. The method of claim 13, wherein said step d. comprises the steps of:
directly affixing an anchor panel to the lateral side of said truck by extending said anchor panel downwardly from a top edge of said truck;
pivotally affixing first and second power-operated lifting arms to each other;
pivotally coupling said first lifting arm coupled to said anchor panel;
directly affixing a U-shaped bracket to said second arm;
operably connecting a plurality of gripping fingers to said U-shaped bracket; and
selectively articulating each of said gripping fingers between compressed and expanded positions.

15. The method of claim 14, wherein step d. further comprises the steps of:
pivotally connecting a proximal end of said first lifting arm to said anchor panel;
directly and pivotally connecting a proximal end of said second lifting arm to said a distal end of said first lifting arm;
pivotally connecting a distal end of said second lifting arm to said U-shaped bracket; and
simultaneously pivoting said first and second lifting arms by adapting said U-shaped bracket from the curbside location towards said collection bin.

16. The method of claim 15, wherein step e. comprises the steps of:
seating a reservoir seated within said collection bin;
depositing a predetermined quantity of a cleaning agent within said reservoir;
electrically coupling a motorized pump directly to said controller;
electrically coupling a power source to said controller and said motorized pump respectively;
seating a sensor within said reservoir by positioning said sensor adjacent to said open top face thereof;
electrically coupling an interface to said motorized pump by located said interface downstream thereof;
electrically coupling a plurality of discharge nozzles to said interface by attaching said discharge nozzles in fluid communication with said reservoir;
electrically coupling a plurality of brushes to said interface;
said motorized pump generating and transmitting first and second input signals to said interface based upon information received from said control signals; and
said sensor generating and transmitting a third input signal to said interface upon detecting a presence of the garbage container within said collection bin.

17. The method of claim 15, wherein step e. further comprises the steps of:
electrically coupling an OR logic gate directly to said motorized pump;
electrically coupling an AND logic gate directly to said sensor and said OR logic gate respectively;
said OR logic gate generating and transmitting a first output signal to said AND logic gate when at least one of said first and second input signals has a true value;
said AND logic gate generating and transmitting a true second output signal when both of said third input signal and said first output signal have true values; and
said AND logic gate generating and transmitting a second output signal have a false value when at least one of said third input signal and said first output signal has a false value.
